(19) United States
(12) Patent Application Publication
(10) Pub. No.: US 2008/0031705 A1
(43) Pub. Date: Feb. 7, 2008

(54) Threaded fastener for use with composite materials

(76) Inventor: Gary Severns, Rochester, IN (US)

Correspondence Address: MACMILLAN SOBANSKI & TODD, LLC, ONE MARITIME PLAZA FIFTH FLOOR, 720 WATER STREET, TOLEDO, OH, 43604-1619, US

(21) Appl. No.: 11/365,974

(22) Filed: Mar. 1, 2006

Related U.S. Application Data
(63) Continuation of application No. PCT/US04/28347, filed on Sep. 1, 2004.
(60) Provisional application No. 60/499,517, filed on Sep. 2, 2003.

(51) Int. Cl. F16B 35/04

(52) U.S. Cl. 411/413; 411/412

(57) ABSTRACT

A threaded fastener, such as a screw, includes a head, a tapered tip portion including a pair of opposing lands disposed between a pair of flutes, and a shank that extends between the head and the tapered tip portion. The shank includes a first threaded portion and a second threaded portion. The first threaded portion of the shank extends along a portion of the shank and at least a portion of the tip portion. The second threaded portion of the shank extends along a portion of the shank between the head and the first threaded portion.

### CROSS-REFERENCE TO RELATED APPLICATIONS

This application is a continuation of International Application No. PCT/US2004/028347, filed Sep. 1, 2004, which claims the benefit of U.S. Provisional Application No. 60/499,517, filed Sep. 2, 2003. The disclosures of both applications are incorporated herein by reference.

### BACKGROUND OF THE INVENTION

This invention relates in general to threaded fasteners. In particular, this invention relates to an improved structure for a threaded fastener that is particularly well adapted for use in drilling through a workpiece that is formed from a composite material.

Various building materials have been traditionally formed from wood or wood products. Although wood is a renewable resource, the high rate of consumption of wood and the availability of alternative materials has spurred the use of composite materials in the construction industry. Composite materials may include a variety of materials, such as glasses or plastics, that are mixed with additional fibers and a binder material. The composite material can be molded or otherwise shaped to produce a finished product with properties similar to the wood product that it will replace. Composite materials may still contain some portion of wood or wood product, such as sawdust. There is an abundance of post-consumer materials that can be recycled to be included in composite materials. Composite materials can also be advantageous in use over the wood products that they replace. Composite materials can be stronger and more durable than similar wood products.

Conventional threaded fasteners that are suitable for use with wood products may be less desirable for use with composite materials because of the increased density of such composite materials. For example, as a threaded fastener (such as a screw) is driven into a workpiece formed from a composite material (without the aid of a pre-drilled hole), the composite material of the workpiece is displaced therefrom, thereby allowing the threaded fastener to enter the workpiece. Some of the displaced composite material can form a mound around the hole created by the threaded fastener. As a result, the displaced material may deform the surface of the workpiece formed from the composite material. Additionally, as a threaded fastener is driven into a workpiece formed from a composite material, shavings of the composite material may be extruded or partially extruded from the hole produced thereby. These shavings may be attached to the composite material or may be trapped against the composite material by the head of the threaded fastener. The shavings and the displaced material are undesirable because they create a rough surface for the composite material around the threaded fastener. The shavings and displaced material also make it difficult to countersink the head of the threaded fastener in the composite material so that the head is flush with or recessed below the surface of the composite material. Thus, it would be desirable to provide an improved structure for a threaded fastener that minimizes or avoids these problems.

### SUMMARY OF THE INVENTION

This invention relates to an improved structure for a threaded fastener, such as a screw. The threaded fastener includes a head, a tapered tip portion including a pair of opposing lands disposed between a pair of flutes, and a shank that extends between the head and the tapered tip portion. The shank includes a first threaded portion and a second threaded portion. The first threaded portion of the shank extends along a portion of the shank and at least a portion of the tip portion. The second threaded portion of the shank extends along a portion of the shank between the head and the first threaded portion.

Various objects and advantages of this invention will become apparent to those skilled in the art from the following detailed description of the preferred embodiment, when read in light of the accompanying drawings.

### BRIEF DESCRIPTION OF THE DRAWINGS

FIG. 1 is a side elevational view, partially in cross section, of a prior art threaded fastener that has been driven into a workpiece formed from a composite material.

FIG. 2 is a side elevational view of an improved structure for a threaded fastener in accordance with this invention.

FIG. 3 is a top plan view of the threaded fastener illustrated in FIG. 2.

FIG. 4 is a bottom plan view of the threaded fastener illustrated in FIG. 2.

FIG. 5 is a side elevational view, partially in cross section, of a lower portion of the threaded fastener illustrated in FIGS. 2, 3, and 4 as it is being initially driven into a workpiece.

FIG. 6 is a side elevational view, partially in cross section, of the threaded fastener illustrated in FIG. 5 after it has been further driven into the workpiece.

FIG. 7 is a side elevational view, partially in cross section, of the threaded fastener illustrated in FIGS. 5 and 6 after the threaded fastener has been completely driven into the workpiece such that a top surface of the head of the threaded fastener is flush with a surface of the workpiece.

### DETAILED DESCRIPTION OF THE PREFERRED EMBODIMENT

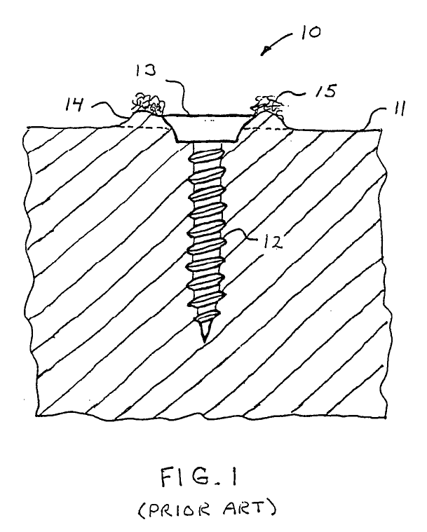

Referring now to the drawings, there is illustrated in FIG. 1 a prior art threaded fastener, such as a screw, indicated generally at 10, that has been driven into a workpiece 11 formed from a composite material. The prior art threaded fastener 10 includes a threaded shank portion 12 and a head portion 13. The prior art threaded fastener 10 can be rotatably driven or drilled into the workpiece 11 in any conventional manner. The composite material of the workpiece 11 is typically not pre-drilled in the location that the prior art threaded fastener 10 is to be received. The composite material of the workpiece 11 may be composed of any desired material or materials, such as glasses or plastics that are mixed with additional fibers and a binder material that are then molded, shaped, and/or compressed to produce a finished product. The composite material of the workpiece 11 may be more dense than a traditional lumber material.

As the prior art threaded fastener 10 is driven into the composite material 11, a portion of the composite material of the workpiece 11 was displaced to allow the prior art threaded fastener 10 to enter the composite material 11. The displaced material may form an annular mound 14 surrounding the head 13 of the screw 10 and extending outward from the surface of the composite material of the workpiece 11. A portion of the displaced material may be shredded and extruded by the thread 12 of the prior art threaded fastener 10 into shavings 15. The shavings 15 may be partially attached to the composite material of the workpiece 11 or trapped between the prior art threaded fastener 10 and the composite material of the workpiece 11. The mound 14 and the shavings 15 deform the surface of the workpiece 11 so that the workpiece 11 no longer has a desired smooth surface. Additionally, the mound 14 and the shavings 15 may make it difficult to drill the prior art threaded fastener 10 so that the prior art threaded fastener 10 is flush with the surface of the workpiece 11.

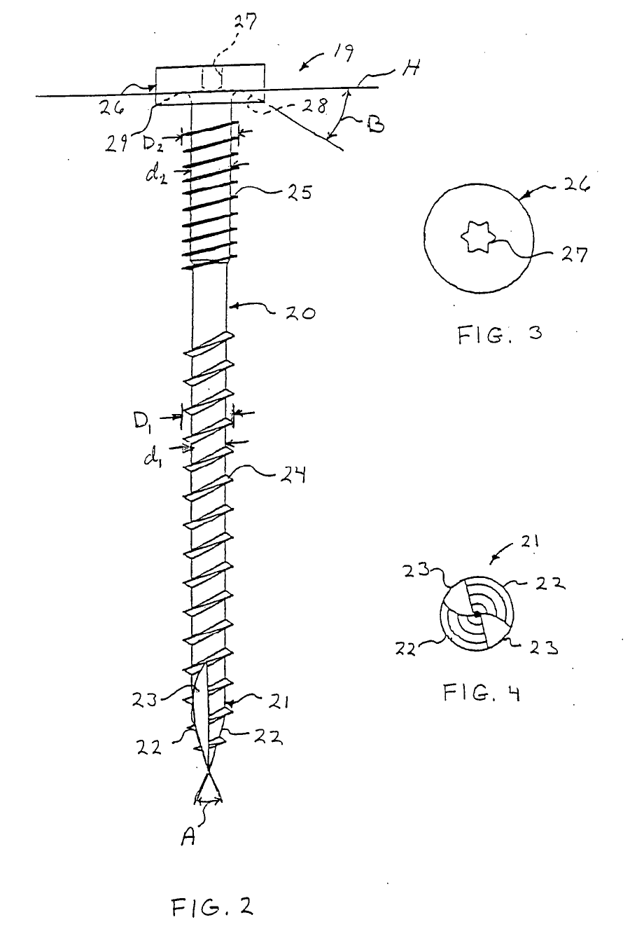

Referring now to FIGS. 2, 3, and 4, there is illustrated an improved structure for a threaded fastener, indicated generally at 19, in accordance with this invention. The threaded fastener 19 includes a shank portion, indicated generally at 20, that terminates in a tapered tip portion, indicated generally at 21. The tapered tip portion 21 tapers at an angle that is illustrated at A in FIG. 2. In the preferred embodiment, the angle A of the tapered tip portion is approximately 36°. However, the angle A of the tapered tip portion can be varied as desired. The tip portion 21 includes first and second lands 22 that are provided on opposing sides of the screw 19, with first and second flutes 23 disposed between such lands 22, as best shown in FIG. 4. In a preferred embodiment, the flutes 23 of the tip portion 21 are each flutes that are suitable for use in a conventional type seventeen screw point, such that the tip portion 21 of the threaded fastener 19 defines a conventional type seventeen screw point. As the threaded fastener 19 is rotatably driven into a material, the lands 22 of the tip portion 21 drill the displaced material of the workpiece 11 to a pulp consistency. The displaced material is expelled from or trapped within the flutes 23 of the tip portion 21.

The lower portion of the shank 20 has a first threaded portion 24 provided thereon. The first threaded portion 24 extends through the lands 22 provided on the tip portion 21. In a preferred embodiment, the thread of the first threaded portion 24 is arranged such that there are from about eight to about twelve threads per inch. In a further preferred embodiment, the thread of the first threaded portion 24 is arranged so that there are about eight threads per inch. It will be appreciated that the number of threads per inch and the turn rate of the first threaded portion 24 may vary as desired and in accordance with the characteristics of the material to be drilled. In a preferred embodiment, a major diameter D₁ defined by the first threaded portion 24 is from about 0.180 inches to about 0.188 inches. In a preferred embodiment, a minor diameter d₁ defined by the first threaded portion 24 is from about 0.118 inches to about 0.128 inches.

The upper portion of the shank 20 has a second threaded portion 25 provided thereon. Preferably, the second threaded portion 25 has a different number of threads per inch than the first threaded portion 24, and the second threaded portion 25 has a slower turn rate than the first threaded portion 24. In a preferred embodiment, the thread of the second threaded portion 25 is arranged so that there are from about fourteen to about eighteen threads per inch. In a further preferred embodiment, the thread of the second threaded portion 25 is arranged so that there are about fourteen threads per inch. It will be appreciated that the number of threads per inch and the turn rate of the second threaded portion 25 may vary as desired and in accordance with the characteristics of the material to be drilled, as well as the number of threads per inch and the turn rate of the first threaded portion 24. In a preferred embodiment, a major diameter D2 defined by the second threaded portion 25 is between about 0.198 inches and about 0.208 inches. In a preferred embodiment, a minor diameter d2 defined by the second threaded portion 25 is between about 0.140 inches and about 0.150 inches.

In a preferred embodiment, the overall length of the threaded fastener 19 is from about two and one-half inches to about three inches. In a further preferred embodiment, the overall length of the threaded fastener 19 is three inches. In a preferred embodiment, the length of the first threaded portion 24 is from about one and one-half inches to about two inches. In a preferred embodiment, the length of the second threaded portion 25 is about one-half inch. In a preferred embodiment, there is about one-quarter inch of the shank 20 that is not threaded that extends between the first threaded portion 24 and the second threaded portion 25. It will be appreciated that the overall length of the threaded fastener 19 and the lengths and relative proportions of the first threaded portion 24 and the second threaded portion 25 may be any desired lengths. The diameter of the shank 20 at the second threaded portion 25 may be larger than the diameter of the shank 20 at the first threaded portion 24, although such is not required. In a preferred embodiment, the threaded fastener 19 is formed from steel, such as, for example, steel conforming to the material specifications of AISI (American Iron and Steel Institute) C1022. In an alternate embodiment, the threaded fastener 19 may be formed from stainless steel, such as stainless steel conforming to the material specifications of AISI 300. It will be appreciated that the threaded fastener 19 may also be formed of any other suitable steel or stainless steel, such as steel or stainless steel conforming to the material specifications of AISI, the Society of Automotive Engineers (SAE) or the Industrial Fasteners Institute (IFI), or any other material. At least a portion of the threaded fastener 19 may be heat treated, although such is not required.

The threaded fastener 19 further includes a head, indicated generally at 26. The head 26 includes an optional drive recess 27 to facilitate the engagement of the head 26 of the threaded fastener 19 by a tool (not shown) for rotatably driving the threaded fastener 19 in the manner described below. It will be appreciated that the head 26 may be shaped to engage a tool for rotatably driving the threaded fastener 19 without the drive recess 27. For example, the head 26 may be a conventional hex head. In a preferred embodiment, the head 26 is a flat head, and the drive recess 27 is a conventional six lobe internal drive recess that is at least 0.060 inches in depth. It will be appreciated that the recess 27 may be any size or shape to engage a rotatably driven tool.

A recess 28 is formed in the lower surface of the head 26, facing downwardly toward the shank 20. The illustrated recess 28 is an annular recess that is defined by an annular skirt portion 29 that depends from the outer periphery of the head 26. In a preferred embodiment, the recess 28 extends about the head 26 outwardly toward the annular skirt portion 29 at an angle that is illustrated at B in FIG. 2. In the preferred embodiment, the angle B is approximately 30° relative to a transverse plane H defined by the head 26 of the threaded fastener 19. It will be appreciated, however, that the recess 28 can be formed having any shape, and further can be formed by any depression and/or extension of the head 26. As will be explained in detail below, the recess 28 is provided to collect and trap loose shavings between the head 26 and the material in which the threaded fastener 19 is drilled. The annular skirt 29 of the head 26 may have a sharp outer edge to aid in forcing the head 26 into a material so that the top of the head 26 is flush with the surface of the material, although such is not required.

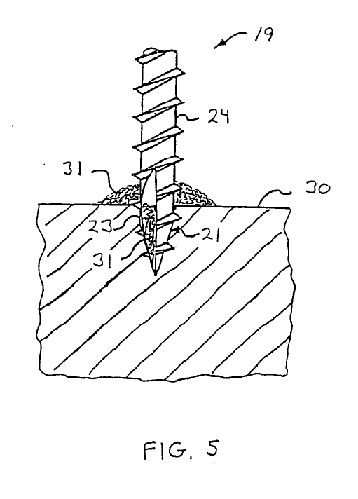

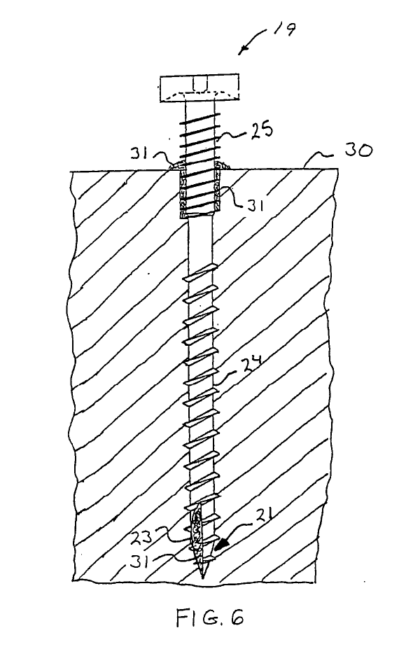

Referring now to FIG. 5, the tip portion 21 of the screw 19 is shown after being initially rotatably driven into a workpiece 30. The workpiece 30 may be formed from any desired material or group of materials, such as glasses or plastics that are mixed with additional fibers and a binder material that are then molded, shaped, and/or compressed to produce a finished product. For example, the workpiece 30 may be formed from a plastic resin and shredded plastic material that is compressed to form a board that is suitable to replace various conventional wood products. The workpiece 30 may be more dense than the traditional lumber product that conventional wood products. The workpiece 30 may also be more fibrous than such conventional wood products.

Because the workpiece 30 is fibrous, as described above, the fibers of the workpiece 30 tend to become free of the binder that binds the fibers together when stressed, such as by the pressure exerted by the threaded fastener 19 as it is rotatably driven into the workpiece 30. These stressed fibers are freed from the binder, but remain a part of the workpiece 30. As the threaded fastener 19 enters the workpiece 30 as shown in FIG. 5, a portion of the workpiece 30 is displaced. The stressed fibers will be displaces such that they extend from the surface of the workpiece 30 and form a mound around the entry point of the threaded fastener 19. Preferably, these fibers are cut loose from the workpiece 30 to prevent undesired displacement.

As the threaded fastener 19 is rotatably driven into the workpiece 30, the lands 22 of the tip portion 21 drill through the portion of the workpiece 30 in the path of the workpiece 19. Such drilling converts the drilled portions of the workpiece 30 into shavings 31 having a pulp consistency. This effectively removes the stressed fibers from the path of the threaded fasteners 19 such that the stressed fibers do not mound around the entry point of the threaded fasteners 19, as described above. A portion of the shavings 31 are then trapped within the flutes 23 of the tip portion 21, and the remainder of the shavings 31 are expelled from the hole created by the threaded fastener 19 in the workpiece 30.

As shown in FIG. 6, the threaded fastener 19 is shown after being further rotatably driven into the workpiece 30. As shown therein, the tip portion 21 is completely surrounded by the workpiece 30, and the flutes 23 of the tip portion 21 have been filled with the shavings 31. Effectively, the tip portion 21 no longer drills the workpiece 30 because the flutes 23 are filled with the shavings 3 1. However, even after the flutes 23 have filled with the shavings 31, the threaded fastener 19 continues to penetrate through the workpiece 30 because of the tapered, threaded point of the tip portion 21. The portion of the workpiece 30 surrounding the hole created by the threaded fastener 19 contains loose fiber because the tip portion 21 is no longer drilling the workpiece 30. The first threaded portion 24 augurs the loose fibers 31 upward toward the surface of the workpiece 30.

Preferably, the threads of the second threaded portion 25 of the threaded fastener 19 have a different threads per inch count and the same or a slower turn rate than the first threaded portion 24 thereof. As a result, the threads of the second threaded portion 25 are dragged through the hole formed by the first threaded portion 24 of the threaded fastener 19 as it is drilled into the workpiece 30. As the second threaded portion 25 is dragged downward away from the surface of the workpiece 30, the second threaded portion 25 traps the loose fiber within and surrounding the hole and pulls the fiber downward between the threads of the second threaded portion 25. Thus, only a relatively small amount of loose fiber is left on or near the surface of the workpiece 30. In a preferred embodiment of the threaded fastener 19, the second threaded portion 25 includes multiple threads turned in the same direction as the threads of the first threaded portion 24. However, it will be appreciated that the second threaded portion 25 could include threads turned in a direction opposite the threads of the first threaded portion 24, or could be replaced with at least one annular flange to perform a similar function.

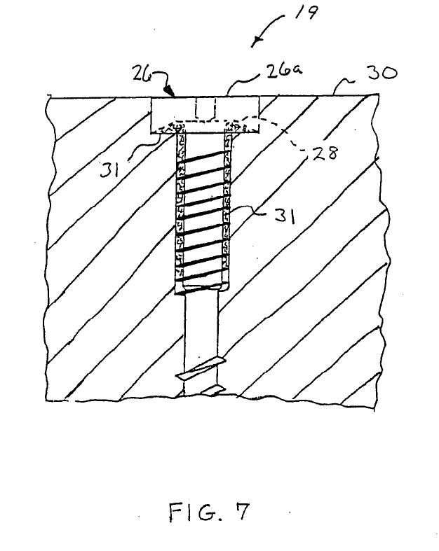

Referring now to FIG. 7, the threaded fastener 19 is shown after being further rotatably driven into the workpiece 30 such that a top surface 26a of the head 26 of the threaded fastener 19 is relatively flush with the surface of the workpiece 30. The shavings 31 that were previously on or around the surface of the workpiece 30 have been trapped by the depending skirt 29 within the recess 28 of the head 26. As the head 26 is driven into the workpiece 30, the remaining shavings 31 are retained within the recess 28 of the head 26. Thus, the shavings 31 are retained within the recess 28, the threads of the first and second threaded portions 24, 25, and the flutes 23 of the screw 19 such that the shavings 31 are contained within the hole created by the threaded fastener 19 in the workpiece 30. Therefore, the head 26 of the threaded fastener 19 can be driven into the workpiece 30 so that the top of the head 26 is flush with the upper surface thereof. The upper surface of the workpiece 30 remains smooth after the threaded fastener 19 is rotatably driven into the workpiece 30 without the aid of a predrilled guide hole.

In accordance with the provisions of the patent statutes, the principle and mode of operation of this invention have been explained and illustrated in its preferred embodiment. However, it must be understood that this invention may be practiced otherwise than as specifically explained and illustrated without departing from its spirit or scope.

1. A threaded fastener comprising:
a head;
a tapered tip portion including a pair of opposing lands disposed between a pair of flutes; and
a shank extending between said head and said tapered tip portion, said shank including a first threaded portion and a second threaded portion, said first threaded portion extending along a portion of said shank and at least a portion of said tip portion, said second threaded portion extending along a portion of said shank between said head and said first threaded portion.

2. The threaded fastener defined in claim 1 wherein a thread of said second threaded portion turns at a slower rate than a thread of said first threaded portion.

3. The threaded fastener defined in claim 1 further including an annular recess provided on a side of said head adjacent said shank.

4. The threaded fastener defined in claim 1 wherein said head is a flat head and includes an internal drive recess.

5. The threaded fastener defined in claim 4 wherein said internal drive recess is a six lobe internal drive recess.

6. The threaded fastener defined in claim 1 wherein said tip portion includes a type seventeen screw point.

7. The threaded fastener defined in claim 1 wherein said head includes a skirt depending from the periphery of said head to form an annular recess, said skirt having a sharp edge.

8. The threaded fastener defined in claim 1 wherein a thread of said second threaded portion is arranged to have a different spacing than a thread of said first threaded portion.

9. The threaded fastener defined in claim 1 wherein a diameter defined by said second threaded portion is larger than a diameter defined by said first threaded portion.

10. The threaded fastener defined in claim 1 wherein a major diameter of said first threaded portion is between about 0.180 and about 0.188.

11. The threaded fastener defined in claim 1 wherein a minor diameter of said first threaded portion is between about 0.118 and about 0.128.

12. The threaded fastener defined in claim 1 wherein a major diameter of said second threaded portion is between about 0.198 and about 0.208.

13. The threaded fastener defined in claim 1 wherein a minor diameter of said second threaded portion is between about 0.140 and about 0.150.

14. The threaded fastener defined in claim 1 wherein a thread of said first threaded portion has about eight to about twelve threads per inch.

15. The threaded fastener defined in claim 1 wherein a thread of said second threaded portion has about fourteen to about eighteen threads per inch.
